(19) United States
(12) Patent Application Publication
(10) Pub. No.: US 2006/0250089 A1
(43) Pub. Date: Nov. 9, 2006

(54) Electric lamp

(75) Inventors: Mathias Hubertus Johannes Van Rijswick, Eindhoven (NL); Walterus Johannes Maria Dekkers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/562,885

(22) PCT Filed: Jun. 25, 2004
(86) PCT No.: PCT/IB04/51007

§ 371 Date: Dec. 29, 2005

(30) Foreign Application Priority Data
Jun. 30, 2003 (EP) 03101945.8

(51) Int. Cl. H01J 61/36

(52) U.S. Cl. 313/623

(57) ABSTRACT

In the electric lamp (31) according to the invention, at least one seal (37) is comprised having at least two feed-throughs (39), the feed-throughs comprising molybdenum foils (45) having foil planes (47). A mutually stacked position of the foil-planes in the seal leads to a very compact double feed-through construction of the lamp. A relatively small lamp is thus obtained.

The invention relates to an electric lamp comprising:

a lamp vessel with a space which is closed in a gastight manner and in which an electric element is arranged;

at least one seal through which at least two electric feed-throughs are passed, which feed-throughs extend from the electric element to outside the lamp vessel;

each feed-through comprising a respective metal foil embedded in the seal, which metal foil has a foil surface bounded on either side by a knife edge, said knife edges extending at least substantially along a longitudinal axis of the lamp.

Such a lamp is known from the patent document U.S. Pat. No. 4,779,026. The known lamp is a “double-ended” lamp, which means that the gastight space is closed at both ends by means of a seal. In a “single-ended” lamp the gastight space is closed at one end only by means of a seal through which a feed-through is passed. In the known lamp, a first electric feed-through is passed through a first seal and a second and a third electric feed-through are passed through a second seal. The metal foil of the first feed-through comprises a foil surface of a chosen standard width. The second and third metal foils have the same orientation in the seal, i.e. the foil surfaces in the known lamp are positioned next to one another, viewed in a direction transverse to the axis along the foil surfaces. The second seal may be made comparatively wide in the known lamp in order to prevent that the second and third metal foils lie too closely together or make electrical contact with one another in the second seal when said standard width is used for the second and third metal foils. The metal foils of the second and third feed-throughs in the known lamp, however, have a width smaller than said standard width so as to prevent the second seal of the known lamp from becoming unacceptably wide. This does indeed achieve that the first seal and the second seal have substantially the same width, which counteracts an unnecessarily great width of the known lamp, but the metal foils are comparatively vulnerable owing to their comparatively narrow surfaces mentioned above and are accordingly susceptible to possible damage. This leads to a comparatively high risk of premature failure of the known lamp, for example during manufacture of the lamp or, for example, owing to a comparatively fast oxidation of one of the narrow metal foils during operation of the lamp in a test phase, caused by the comparatively small quantity of material of this foil.

It is an object of the invention to provide a lamp of the kind described in the opening paragraph in which the above disadvantages are counteracted. The lamp described in the opening paragraph is for this purpose characterized in that the foil surfaces of the feed-throughs present in one and the same seal are situated in different planes. The plane in which a respective foil surface is situated is defined as the plane in which the knife edges of the relevant metal foil are situated. The foil surfaces may be arranged, for example, mutually mirrored with respect to the longitudinal axis or, in the case of two (or more) feed-throughs through one seal, arranged along the longitudinal axis in some other dual (or multiple) rotational symmetry. The measure renders it possible to obtain an acceptable width of the seal in spite of the use of metal foils having a standard width, while retaining their robustness. Upon projection of the metal foils along a line perpendicular to the plane of one of the metal foils, the projected joint width of the metal foils and the projected distance between the metal foils will be smaller than the sum of the individual widths of the metal foils and the actual shortest distance between the metal foils. The manufacture of a seal having a smaller, acceptable width can thus be realized. The lamp according to the invention is embodied in both double-ended and single-ended lamps, in which two or more lead-throughs are passed at least through one seal.

In a favorable embodiment, the electric lamp according to the invention is characterized in that the foil surfaces are oriented parallel to one another. It is achieved thereby that the shortest mutual distance between the metal foils is substantially no longer determined by the width of the metal foils, but rather by the distance between the foil surfaces in a direction perpendicular to the foil surfaces. This renders possible a more compact embedding of the metal foils in the seal, so that the seal can have still smaller dimensions. Preferably, the metal foils are arranged with their foil surfaces facing one another in transverse direction, such that the compactness of the embedding is a maximum, and the dimension of the relevant seal can be a minimum, which is favorable in the context of the continuous tendency towards miniaturization of high-pressure gas discharge lamps and halogen lamps.

The patent document U.S. Pat. No. 6,400,077 discloses an electric lamp in which the lamp vessel is folded double, such that the lead-throughs are situated next to one another in separate seals, with their foil surfaces arranged in mutual opposition. A lamp of such a shape on the one hand has comparatively large dimensions, while on the other hand the lamp requires a comparatively large number of operations for its manufacture, because a separate seal is necessary for each feed-through.

Further features of the lamp according to the invention will be explained in more detail with reference to the drawing, in which:

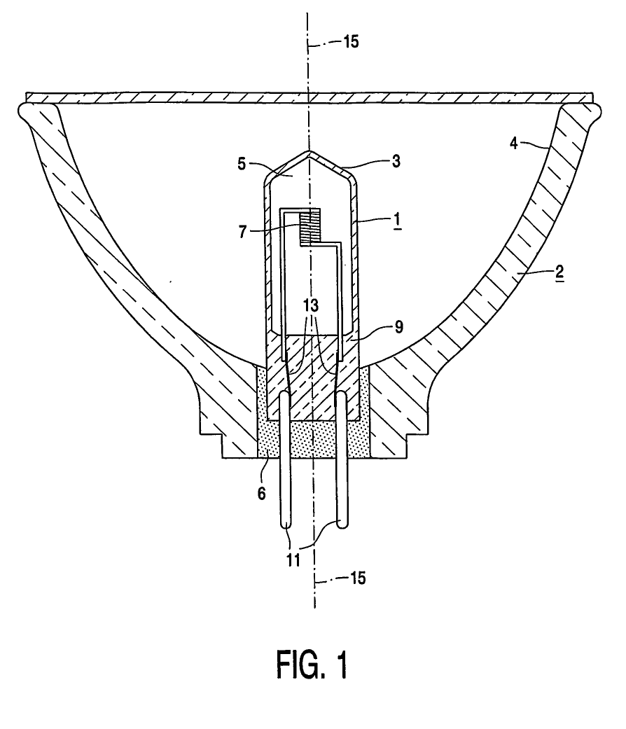

FIG. 1 is a cross-sectional view of a single-ended halogen incandescent lamp/reflector unit; and

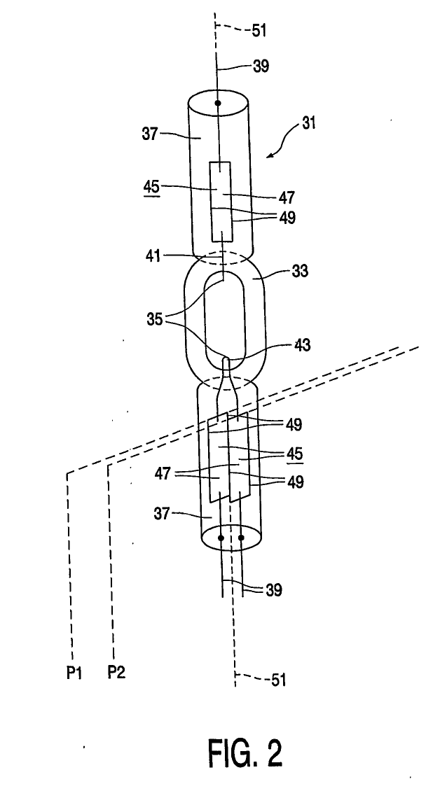

FIG. 2 is a perspective view of a double-ended discharge lamp.

FIG. 1 shows a single-ended halogen lamp 1 which forms a unit with a reflector 2 in that the lamp has been fastened by a seal 9 of the lamp in a neck opening 6 of the reflector by means of cement. The halogen lamp is manufactured from a glass tube with a diameter of 7 mm and a wall thickness of 1 mm, the glass material being quartz glass, i.e. glass with an SiO₂ content of at least 95% by weight. The lamp 1 comprises a lamp vessel 3 with a space 5 which is closed in a gastight manner and in which an electric element 7, a filament in FIG. 1, is positioned. The lamp is closed off by means of the seal 9, through which two electric feed-throughs 11 are passed, which feed-throughs extend from the electric element to outside the lamp vessel. The feed-throughs each comprise a respective metal foil 13 embedded in the seal and manufactured from at least substantially molybdenum. Each metal foil has a respective foil surface which is bounded on either side by a respective knife edge (see FIG. 2). The knife edges extend at least substantially along a longitudinal axis 15 of the lamp. The foil surfaces of the feed-throughs present in the seal are arranged in a stacked position, i.e. they are situated in mutually different, mutually parallel planes opposite one another, which planes are perpendicular to the plane of drawing (FIG. 1). The seal is of the collapsed type. A “collapsed seal” can be obtained in that the glass tube is locally heated, whereupon it is caused to flow against and around the relevant metal foils by means of an underpressure, so that the metal foils are embedded in the glass and a gastight seal of the lamp is achieved. The metal foils are 5 mm long, 2.4 mm wide, and have a greatest thickness of 25 μm. The mutually stacked positions of the metal foils in the seal cause the seal 9 to have a greatest dimension in a direction perpendicular to the longitudinal axis which is at most equal to the dimension of the lamp vessel 3 in directions perpendicular to the longitudinal axis. As a result, the reflector has a comparatively large reflecting surface 4 and a comparatively small neck opening 6, so that light losses caused by light incident on the neck opening are counteracted. The halogen incandescent lamp shown has a filling of 800 mbar of xenon with 450 ppm CH₂Br₂. The filament is manufactured for a rated operation at 12 V/50 W.

FIG. 2 shows a double-ended discharge lamp 31 provided with a quartz glass lamp vessel 33 having a closed, gastight space 34 in which a pair of electrodes is arranged as the electric element 35. The electric element is connected to feed-throughs 39 passed through seals 37, which feed-throughs extend to outside the lamp vessel. The discharge lamp has a single electrode 41 at one end and a starter electrode 43 at an opposite end, for which purpose two lead-throughs 39 are required in the seal 37. Each feed-through comprises a molybdenum metal foil 45 embedded in the seal 37. Each metal foil has a respective foil surface 47 which is bounded on either side by a respective knife edge 49. The knife edges extend at least substantially along a longitudinal axis 51 of the lamp. The foil surfaces of the feed-throughs present in the seal are arranged opposite to one another in mutually different, parallel planes P1, P2. Owing to this stacked position of the metal foils in the seal, said seal with two feed-throughs has dimensions equal to the dimensions of the seal with a single feed-through situated opposite thereto. The discharge lamp shown has a lamp filling in its gastight space comprising mercury with iodides of sodium and scandium and with xenon, for example at a pressure of 100 bar during lamp operation, which xenon acts as a starter gas. The lamp has a rated power of 35 W and is suitable for use in optical systems such as, for example, a projector or an automobile headlight.

1. An electric lamp comprising:
a lamp vessel with a space which is closed in a gastight manner and in which an electric element is arranged;
at least one seal through which at least two electric feed-throughs are passed, which feed-throughs extend from the electric element to outside the lamp vessel;
each feed-through comprising a respective metal foil embedded in the seal, which metal foil has a foil surface bounded on either side by a knife edge, said knife edges extending at least substantially along a longitudinal axis of the lamp,
characterized in that the foil surfaces of the feed-throughs present in one and the same seal are situated in different planes.

2. An electric lamp as claimed in claim 1, characterized in that the foil surfaces are oriented parallel to one another.

3. An electric lamp as claimed in claim 2, characterized in that the foil surfaces are arranged opposite to one another.
